(19) United States
(12) Patent Application Publication
(10) Pub. No.: US 2007/0299695 A1
(43) Pub. Date: Dec. 27, 2007

(54) Customized visual marking for medication labeling

(75) Inventors: Edward K.Y. Jung, Bellevue, WA (US); Royce A. Levien, Lexington, MA (US); Robert W. Lord, Seattle, WA (US); Mark A. Malamud, Seattle, WA (US); John D. Rinaldo, Bellevue, WA (US); Lowell L. Wood, Livermore, CA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporation of the State of Delaware

(21) Appl. No.: 11/524,084

(22) Filed: Sep. 19, 2006

Related U.S. Application Data
(63) Continuation-in-part of application No. 11/474,109, filed on Jun. 23, 2006.

(51) Int. Cl. G06F 19/00; G06F 17/00; G06K 19/06

(52) U.S. Cl. 705/3; 707/104.1; 235/494

(57) ABSTRACT

Exemplary embodiments are disclosed that provide a customized technique for marking medication and other health-related products with a visual identifier that includes a recognizable symbolic aspect to facilitate proper administration of a substance dosage to designated patent. Display implementations of the visual identifier may be incorporated in various product packaging components. A possible supplemental visual identifier may be incorporated in the product packaging components to suggest recommended usage aspects of the substance dosage.

### BACKGROUND

Medications and other health-related products may need special labeling to help assure proper administration of a dosage to a designated patient.

### SUMMARY

Various embodiments and implementations are disclosed herein with respect to improved labeling for medications and other health-related products.

Some embodiments for a packaging system for medication or other health-related products may include a substance dosage designated for use by a particular patient, a container for holding one or more substance dosages, labeling that includes substance administration information, and a visual identifier that includes one or more recognizable primary symbolic aspects intended to facilitate identification of the particular patient. A further possible feature may include a display implementation for the visual identifier, which display implementation is in close association with the substance dosage.

An exemplary process embodiment for a method of marking a medication or other health-related product may include establishing a visual identifier for a health-related substance designated for use by a particular patient, which visual identifier includes a primary recognizable symbolic aspect intended to facilitate identification of the particular patient; and providing a display scheme for incorporating the visual identifier in close association with a substance dosage.

An exemplary embodiment for a medication or other health-related product may include a health-related substance designated for use by a particular patient; a visual identifier that includes one or more recognizable primary symbolic aspects intended to facilitate identification of the particular patient; and a substance dosage to be administered internally or externally to the particular patient, which substance dosage incorporates the visual identifier as an integral display characteristic of the actual substance dosage and/or as a display element of a package or label in close association with the actual substance dosage.

Another possible packaging system embodiment may include a substance dosage of the health-related product that is designated for a particular patient; a visual identifier that includes a primary recognizable symbolic aspect intended to facilitate identification of the particular patient; and one or more additional components for use in connection with administration of the health-related product, wherein each such additional component displays one or more symbolic aspects of the visual identifier. A further possible packaging system aspect may include a display implementation that incorporates the visual identifier to be integral with the substance dosage or to be integral with a packet or container for the substance dosage.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES.

FIG. 1 is a schematic representation of exemplary embodiments for labeling medication or other health-related products.

FIG. 2 is a schematic representation of additional exemplary embodiments for labeling medication or other health-related products.

FIG. 3 is a schematic illustration of an exemplary implementation applicable for medical kit components.

FIG. 4 shows a schematic diagram for communicating product information to a patient or other interested party.

FIG. 5 is a high level flow chart for an exemplary process embodiment.

FIGS. 6-10 are flow charts showing more detailed aspects of various exemplary process embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The display techniques disclosed herein may be adapted for providing customized labeling for many types of medications and other health-related products. Accordingly it is not possible to recite a complete listing of such medications and health-related products.

However it may be helpful to understand that pharmaceutical products can be formulated, manufactured and administered in many different ways for the benefit of designated patients. Such pharmaceutical products can incorporate many aspects of the exemplary methods, systems, packaging, and products disclosed herein. In-that regard the following commonly assigned pending application is incorporated herein by reference: Ser. No. 11/453,571 entitled “Individualized Pharmaceutical Selection and Packaging”, filed 14 Jun. 2006.

It may also be helpful to understand that various health-related products that do not require physician approval or prescription (nutritional supplements, natural remedies, nutraceuticals, etc.) can be formulated, manufactured and administered in many different ways for the benefit of designated patients. Such health-related products can incorporate many aspects of the exemplary methods, systems, packaging, and products disclosed herein. In that regard the following commonly assigned pending application is incorporated herein by reference: Ser. No. 11/314,945 entitled “Generating a Request From a Nutraceutical Inventory”, filed 20 Dec. 2005.

It will be further understood that such enhanced labeling may be practiced by many types of persons and entities including but not limited to manufacturers, distributors, wholesalers, retailers, hospitals, hospices, convalescent homes, emergency care facilities, pharmacies, health insurance providers, HMOs, clinics, home nursing services, and the like. Accordingly the illustrated embodiments that are disclosed herein may be specifically different from the many types of health-related products and medications made, used or sold by such persons or entities. Nevertheless it is believed that the various aspects and implementations for the customized labeling techniques disclosed herein can be adapted for the benefit of such persons and entities as well as for the benefit of their patients.

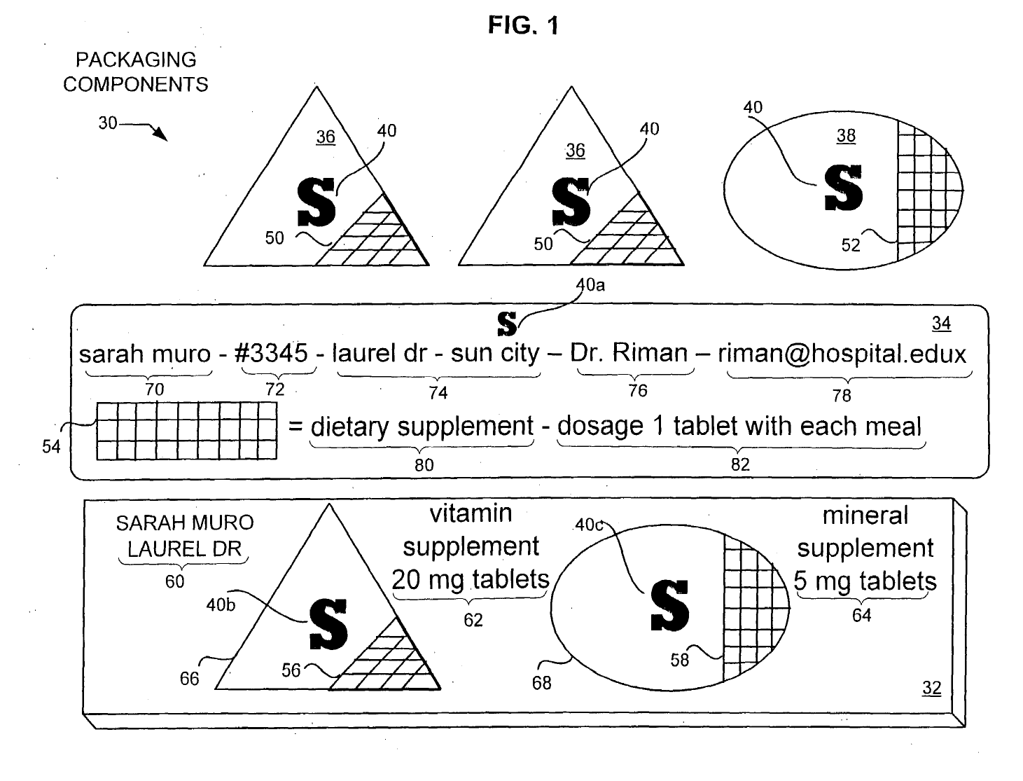

The exemplary packaging components 30 shown in FIG. 1 include container 32, cross-reference sheet 34, tablets 36, and tablet 38. Customized labeling that includes a display of visual identifiers on one or more of the packaging components 30 may serve to assist patients, medical personnel, and caregivers in correctly administering a substance dosage to the patient. The visual identifier may include various types of recognizable primary symbolic aspects that are displayed in close association with a substance dosage to facilitate identification of a patient, or group of patients, who are intended recipients of such substance dosage.

The illustrated primary symbolic aspects shown to be integral with tablets 316 may include a triangular tablet shape, an S monogram 40, and a partial checkerboard pattern 50 covering one or more surfaces of a corner portion of the tablets 36. The illustrated primary symbolic aspects shown to be integral with tablet 38 may include an elliptical tablet shape, an S monogram 40, and a partial checkerboard pattern 52 covering one or more surfaces of an end portion of the tablet 38.

It will be understood that a recognizable color (not shown) or recognizable texture (not shown) or other distinguishable visual feature may also be adopted to be integral with a tablet dosage such as 36, 38 to help identify an intended patient or group of patients. For example all dietary supplement tablets with similar ingredients that are intended for a grouping of nutritional deficient patients may incorporate similar versions of the partial checkerboard patterns 50, 52, but also incorporate additional individualized primary symbolic aspects (e.g., abbreviation, color, shape, etc.) that serve as customized individual patient identifiers rather than group patient identifiers. In some situations a particular dietary supplement patient may need a specified mega-dose of a given supplement twice a day, and another patient may need a different specified mild dose of that same given supplement once a day. Depending on the nature of the health issues, other criteria (e.g., same attending physician, same medical insurance, similar patient risk of side effects, members of experimental testing group, etc.) may be used for grouping categories of patients to be associated with a particular type of primary symbolic aspect that is displayed in close association with a substance dosage.

The cross-reference sheet 34 may include an expanded recitation of patient identification data correlated with a primary symbolic aspect integral with the tablets 36, 38. For example cross-reference sheet 34 shows a correlation between an S monogram depiction 40a and a particular patient with a patient name 70 such as Sarah Muro, identification indicia 72 such as #3345, a residence address 74 such as Laurel Drive in Sun City, a responsible physician 76 such as Dr. Riman, and the responsible physician's email address 78 such as “riman@hospital.edux”.

As further illustrated on the cross-reference sheet 34, the partial checkerboard pattern 50, 52 may not only serve as a group or individual patient identifier, but also may function as a supplemental visual identifier intended to suggest pertinent product administration information for tablets 36, 38. In that regard the cross-reference sheet 34 shows a correlation between a checkerboard pattern depiction 54 with a product substance category 80 such as “dietary supplement”, and with a substance administration guideline 82 such as “dosage one tablet with each meal”.

The product container 32 may also serve as a cross-reference display implementation. For example the product container 32 includes a reproduced depiction 66 of triangular tablet 36 with S monogram 40b and checkerboard pattern 56. Such depiction 66 is positioned on a side panel of the container 32 to correlate with a particular patient identification 60 such as “Sarah Muro Laurel Dr”. Such depiction 66 additionally is positioned on a side panel of container 32 to correlate with a product identification 62 such as “vitamin supplement 20 mg tablets”.

As another example of cross-reference display implementation, the product container 32 includes a reproduced depiction 68 of elliptical tablet 38 with S monogram 40c and checkerboard pattern 58. Such depiction 68 may be positioned on a side panel of the container 32 to correlate with a particular patient identification 60 such as “Sarah Muro Laurel Dr”. Such depiction 68 additionally may be positioned on a side panel of the container 32 to correlate with a specific product identification 64 such as “mineral supplement 5 mg tablets”.

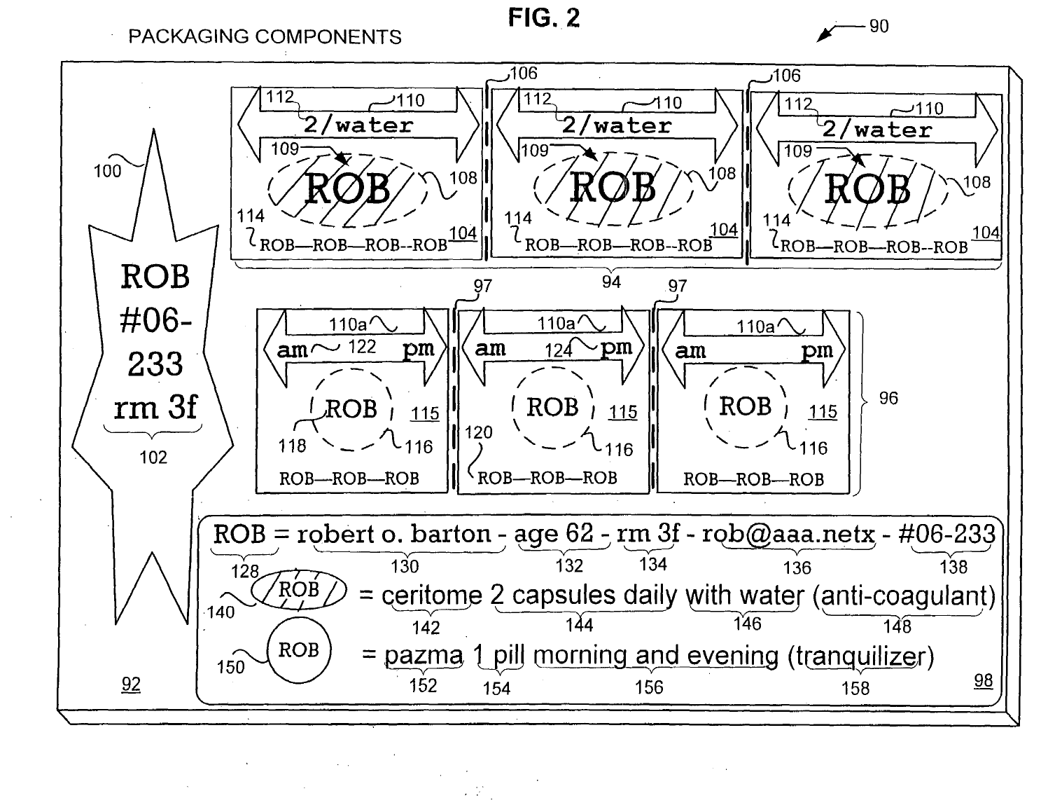

Referring to the schematic diagram of FIG. 2, another exemplary embodiment of packaging components 90 may include a container 92, a collection 94 of sealed rectangular packets 104 each containing a capsule I 08 (shown with phantom outline), a collection 96 of sealed square packets 115 each containing a pill 1 16 (shown with phantom outline), and cross-correlation component 98. Perforated boundaries 106 are provided for optional manual separation of each individual rectangular packet 94 prior to opening the packet for removal of a capsule 108. Similar perforated boundaries 97 are provided for optional manual separation of an individual square packet 115 prior to opening the packet to remove a pill 116.

The illustrated principal visual identifier shown to be integral with tablet 108 may include specified recognizable symbolic aspects such as an oblong capsule shape, and a composite design 109 that includes a stylized ROB abbreviation superimposed on a diagonal background. An additional principal visual identifier shown to be integral with sealed rectangular packet 104 may include specified symbolic aspects such as a four-part ROB chain design 1 14 displayed along a lower packet edge.

An illustrated supplemental visual identifier shown to be integral with sealed rectangular packet 104 includes specified recognizable symbolic aspects that are suggestive of substance dosage guidelines. An exemplary specified recognizable symbolic aspect may be a double-head arrow format 110 with an alphanumeric abbreviation 112 such as “2/water”.

Referring again to the packaging components 90 of FIG. 2, an illustrated principal visual identifier shown to be integral with tablet 116 includes specified recognizable symbolic aspects such as a circular pill shape, and a stylized ROB abbreviation 118. An additional principal visual identifier shown to be integral with sealed rectangular packet 1 15 includes specified recognizable symbolic aspects such as a three-part ROB chain design 120 displayed along a lower packet edge.

An illustrated supplemental visual identifier shown to be integral with sealed rectangular packet 115 includes specified recognizable symbolic aspects that are suggestive of substance dosage guidelines. An exemplary specified recognizable symbolic aspect may be a double-head arrow format 110a that includes alphanumeric abbreviations 122, 124 such as “am” and “pm”.

The cross-correlation sheet 98 shown in FIG. 2 may include an expanded recitation of pertinent patient information correlated with primary symbolic aspects 1 09 that are integral with tablets 108, 116. For example a reproduced stylized ROB abbreviation 128 is correlated with a particular patient having a patient name 130 such as Robert O. Barton, a patient demographic 132 such as age 62, a hospital location 134 such as room 3f, a patient email address such as rob@aaa.comx, and a hospital admittance identification 138 such as #06-233.

As further illustrated on the cross-correlation sheet 98, a reproduced capsule depiction 140 with a composite design (e.g., stylized ROB abbreviation and diagonal background) is correlated with pertinent product information. For example an illustrated correlation establishes a cross-reference between specified symbolic aspects 110, 112 of capsule 100 g and its informational administration guidelines. Such informational administration guidelines may recite a capsule brand or descriptive name 142 such as “ceritome”, an applicable product category 148 such as “anti-coagulant”, a dosage size and frequency instruction 144 such as “two capsules daily”, and supplemental dosage administration instructions 146 such as “with water”.

Similarly a further exemplary feature on the cross-correlation sheet 98 may include a reproduced pill depiction 150 with stylized ROB abbreviation 118 that is correlated with pertinent product information. For example an illustrated correlation establishes a cross-reference between specified symbolic aspects 110a, 122, 124 of pill 116 and its informational administration guidelines. Such informational administration guidelines may recite an applicable pill brand or descriptive names such as “pazma”, a product, category 158 such as “tranquilizer”, a dosage size 154 such as “one pill”, and dosage frequency instructions 156 such as “morning and evening”.

The exemplary product container 92 of FIG. 2 may include a recognizable visual identifier intended to facilitate identification of a particular patient. Such an exemplary visual identifier may include a primary recognizable symbolic aspect that includes an elongated seven point geometric design 100 combined with an alphanumeric abbreviation 102 such as “ROB #06-233 rm 3f′.

It will be understood from the disclosed embodiments herein that each display of a visual identifier and/or a supplemental visual identifier on the various components of the packaging ensemble will facilitate proper administration of a correct substance dosage to the intended recipient. In that regard the primary and specified symbolic aspects of such visual identifiers include visual elements that can be recognizable without need of a scanner-like device.

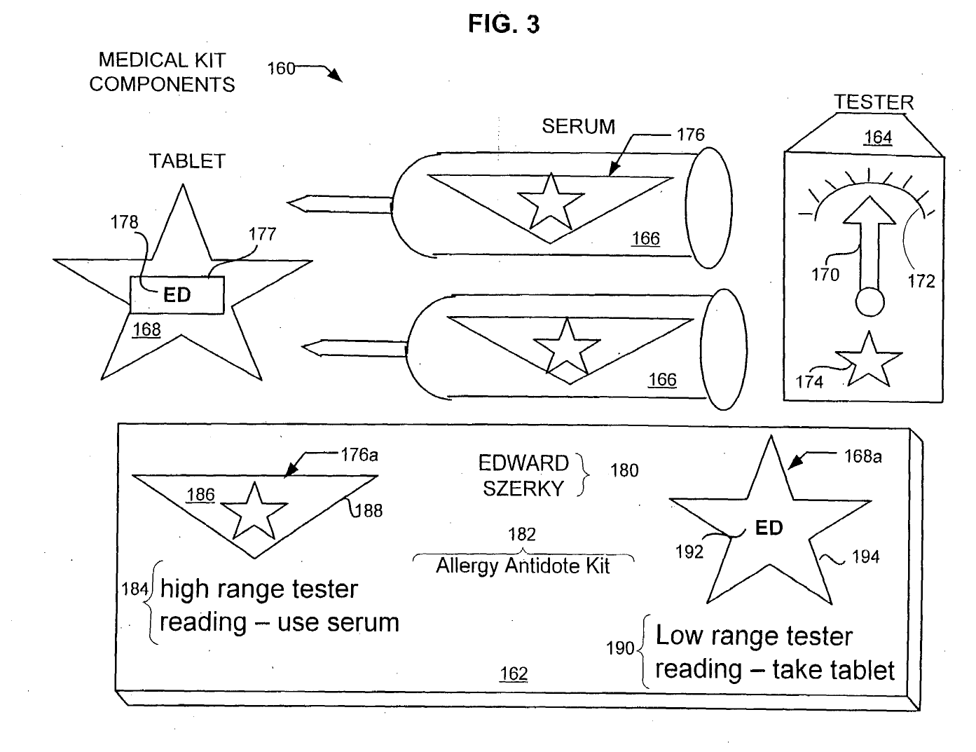

Referring to the exemplary medical kit components 160 illustrated in FIG. 3, a container 162 is provided for a tester 164, hypodermic serum syringes 166, and one or more tablets 168. The tester may include a sensor that is operably coupled to a pivotally mounted indicator arm 170 that registers an output reading against a measurement scale 172. Of course it will be understood that there are innumerable types of diagnostic, measurement, and treatment kits that may embody the various labeling features disclosed herein. The exemplary embodiment of FIG. 3 is by way of illustration only, and is not intended to be limiting.

A geometric design symbol 174 of a five point star may be incorporated as an integral visual part of tester 164. The geometric design symbol 174 may serve a dual purpose as both a visual identifier that correlates with a particular patient (or group of patients) and a supplemental visual identifier that is suggestive of a particular remedial allergy treatment. Similarly a composite triangle/star design symbol 176 that is displayed on a label affixed to the serum syringes 166 may also serve a dual purpose as a patient visual identifier and also as a supplemental visual identifier for product usage information.

The nickname symbol ED 178 that is displayed on a removable label 177 attached to tablet 168 serves as a patient visual identifier, and when displayed in combination with a five point star shape forms an integral part of the tablet 168, such combination may in some instances also function as a supplemental visual identifier for product administration information..

In the embodiment of FIG.3, a cover portion of the container 162 is used as a cross-reference display implementation. For example, a composite symbol depiction 168a with five point star 194 and nickname symbol ED 192 is displayed on container 162 in adjacent relationship to an enlarged patient name display EDWARD SZERKY 180 to establish a patient correlation with each of the kit components 162, 164, 166, 168 bearing the star symbol. The positioning on container 162 of the patient name EDWARD SZERKY 180 in adjacent relationship to a product category 182 such as “Allergy Antidote Kit” 182 also provides further patient correlation with all of the medical kit components 160 and also with the treatment goal (e.g., allergy antidote) of the kit.

The exemplary embodiment of FIG. 3 also displays the composite symbol depiction 168a (e.g., five point star 194 surrounding nickname ED symbol) positioned in adjacent relationship on the container 162 to a product instructional guideline 190 reciting “Low range tester reading—take tablet”. Such cross-reference display on the container 162 establishes a product usage correlation with kit components 164, 168.

Another cross-reference display implementation on container 162 includes a composite design symbol depiction 176a with five point star 186 inside a triangle symbol 188. The display of such composite design depiction 176a is positioned in adjacent relationship to an instructional guideline 184. The exemplary instructional kit guideline 184 recites “high range tester reading—use serum” to establish a product usage correlation with each kit component 164, 166.

It will be understood that various types of identifier symbols integral with an actual medication or other health-related dosages (e.g., tablet, capsule, pill, etc.) may be created as part of a substance manufacturing process, or may be subsequently provided as an edible addition on a dosage surface. In some instances identifier symbols as disclosed herein may also be incorporated as part of a removable label for a dosage surface.

As disclosed herein, it will be understood that a medication or other health-related product may have a visual identifier that includes a recognizable primary symbolic aspect intended to facilitate identification of one or more particular patients with a given symptom or deficiency. A related aspect of a visual identifier may include one or more recognizable primary symbolic aspects intended to facilitate identification of one or more particular patients having a shared affiliation or grouping.

Further possible implementations may provide a visual identifier that includes a recognizable primary symbolic aspect that is capable of facilitating identification of one or more particular patients who are intended recipients of the substance dosage without need of any scanner-like device. Other possible implementations may provide cross-reference data information for correlating one or more particular patients with their respective visual identifiers. In some embodiments the cross-reference information may be accessible at one or more of the following locations: database, patient ID tag, patient profile, medication list, patient chart, patient profile, pharmacy, nurse station, caretaker facility, caregiver instructions, healthcare regimen recommendations, product packaging, prescription document, prescription record, insurance record, user profile, and online profile.

Some product embodiments may include a substance dosage that incorporates the visual identifier having a distinguishable shape or color or pattern or texture as an integral display characteristic of the actual substance dosage. Further possible exemplary product embodiments may include packaging or labeling for the substance dosage, wherein one or more of the following types of visual identifier are incorporated as the supplemental display element on the packaging or labeling: name abbreviation, name initials, nickname, gender, age, height, weight, patient photo, address, attending physician, prescribing physician, caregiver, alias, avatar, buddy icon, URL, ID, affiliation, alphanumeric, text, graphic, color, pattern, format, shape, texture, and indicia.

In some embodiments a product implementation may include a supplemental visual identifier in close association with the actual substance dosage, which supplemental visual identifier includes one or more specified recognizable symbolic aspects that are intended to suggest proper administration of the health-related substance.

An additional product embodiment may include separate dosages of different health-related substances that each display one or more symbolic aspects of the visual identifier. Another possible product embodiment may include separate dosages of pharmaceutical and non-pharmaceutical products that each display one or more symbolic aspects of the visual identifier.

A further possible product embodiment may include one or more additional components for use in connection with administration of the heal-related substance, wherein such additional component displays one or more symbolic aspects of the visual identifier.

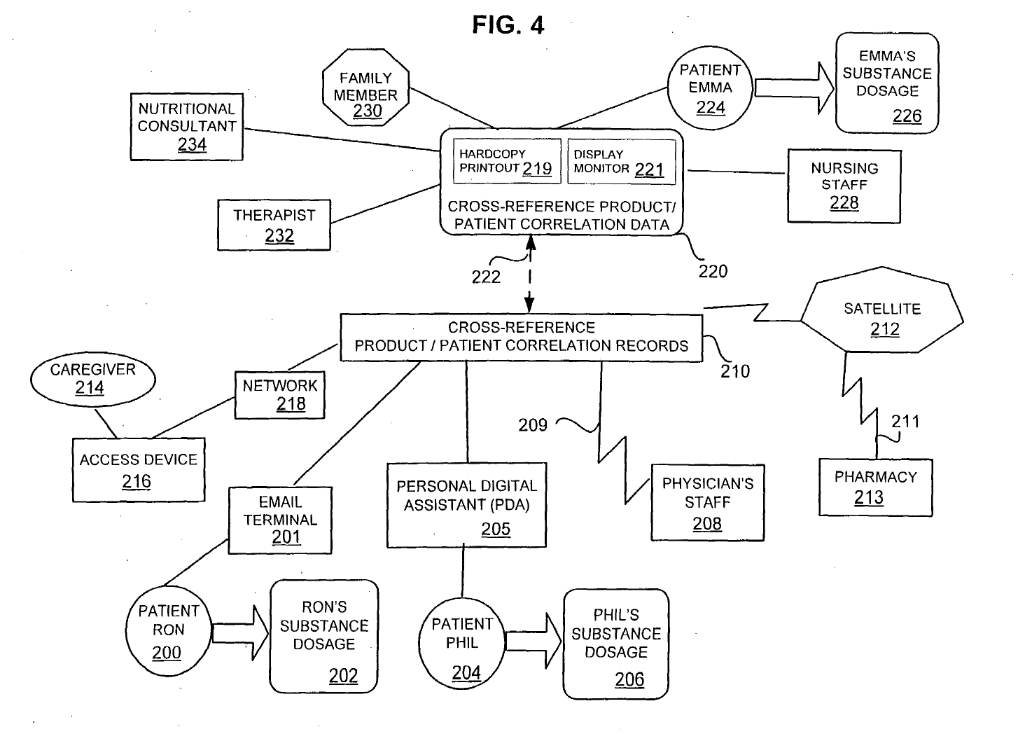

Referring to the schematic diagram of FIG. 4, various exemplary embodiment features that may be available for use with one or more patients are illustrated. The schematic diagram illustrates a patient Ron 200 having a designated substance dosage 202, and another patient Phil 204 having a designated substance dosage 206. In order to make pertinent patient information available to interested parties, cross-reference product/patient correlation records 210 may be stored or maintained at a local or central location. Remote access to such correlation records may be achieved in many ways. For example patient Ron may have access by using an email terminal 201, and patient Phil may have access by using a personal digital assistant (PDA) 205. A display screen may also be provided in close proximity to a patient thereby eliminating a need for each interested party to have their own communication link to the records 210.

Additional remote access to the cross-reference product/patient correlation records 210 may be provided to a physician's staff 208 via wireless connection 209. Other access links such as a wireless connection 211 via satellite 212 may be provided to a pharmacy 213. In addition a caregiver 214 may use access device 216 that is connected via network 218 to the cross-reference product/patient correlation records 210. This enables many interested parties to be involved in helping to achieve proper administration of medications or other health-related products to one or more patients. It will be understood by those skilled in the art that various access protocols may be adopted to establish secure read/write access procedures and thereby maintain data integrity for the correlation records.

As disclosed herein, certain portions of the records 210 may indicate a correlation between visual identifiers displayed in close association with a substance dosage and one or more patients who are the intended recipients of the substance dosage. Other portions of the records 210 may indicate a correlation between supplemental visual identifiers displayed in close association with a substance dosage and substance administration guidelines/goals for the health-related product.

Some exemplary embodiments shown in FIG. 4 may provide a hardcopy printout 219 of the cross-reference product/patient correlation data 220. Such a hardcopy version may be directly available to patient Emma 224 in connection with administration of her designated substance dosage 226. Other interested parties may also have direct access to a hardcopy printout 219 of such correlation data 220, including members of the nursing staff 228, a family member 230, therapist 232 and nutritional consultant 234.

It will be further understood that a display monitor 221 or other shared output device may also be directly available to the patient Emma 224 and/or other interested locally available parties.

As shown by fragmented arrow 222, the printout version or the display monitor version of the correlation data 220 may be generated from or based on the stored version of the correlation records 210. In some instances the printout version may be separately prepared to be included as part of the packaging for the substance dosage that is delivered to the patient. Of course the amount of detailed information provided in any version of the cross-reference information can be varied depending on the circumstances. Other distribution and display techniques may be used, and the exemplary embodiment features disclosed herein are for purposes of illustration and are not intended to be limiting.

Various possible packaging embodiments may be implemented for a medication or other health-related product that incorporates aspects of the customized labeling aspects disclosed herein. For example a display implementation for a visual identifier may include one or more of the following type of distinguishable characteristics: color, shape, pattern, texture, format, graphic, image, text, alphanumeric, and indicia.

Other possible packaging implementation features may include a display implementation incorporated as an integral part of the container, and may be incorporated as an integral part of the substance dosage. In some instances the display implementation for the visual identifier may be incorporated on permanent or removable labeling.

Some packaging system embodiments may include cross-reference data information for correlating one or more particular patients with their respective visual identifiers, which cross-reference data information is available to the a family member or caregiver or medical personnel having responsibility for the particular patient. A further aspect may provide a data record for cross-reference data information, which data record is accessible at one or more of the following locations: database, patient ID tag, patient profile, medication list, patient chart, patient profile, pharmacy, nurse station, caretaker facility, caregiver instructions, healthcare regimen recommendations, product packaging, prescription document, prescription record, insurance record, user profile, and online profile.

As disclosed herein, another possible packaging aspect may provide one or more additional components for use in connection with administration of the health-related substance, wherein such additional component displays one or more symbolic aspects of the visual identifier. Another possible packaging aspect may provide a symbolic display element on one separate component of the packaging system that is correlated with a related symbolic display element on another component of the packaging system.

A further possible packaging feature may provide a symbolic display element incorporated as part of the substance dosage, and a related symbolic display element incorporated as part of a container for the substance dosage. Other possible implementation features for an exemplary packaging system may include a symbolic display element incorporated as part of the substance dosage, and a related symbolic display element incorporated as part of the labeling.

In some instances a packaging system embodiment may include a symbolic display element that serves a dual function intended to facilitate identification of a particular patient as well as intended to suggest proper administration of the health-related substance.

Further packaging aspects disclosed herein may include a supplemental visual identifier in close association with the substance dosage, which supplemental visual identifier includes one or more specified recognizable symbolic aspects intended to suggest proper administration of the health-related substance. A related packaging aspect may provide one or more primary recognizable symbolic aspects that are distinguishable as compared to the specified recognizable symbolic aspects of the supplemental visual identifier.

Further packaging system implementation features may include a cross-reference to correlate substance administration or health-related issues with their respective specified recognizable symbolic aspects. Another packaging feature may provide a display implementation for the visual identifier that includes display elements capable of visual recognition without need of a scanner-like device.

It will be understood by those skilled in the art that the various components and elements disclosed in the block diagrams herein as well as the various steps and sub-steps disclosed in the flow charts herein may be incorporated together in different claimed combinations in order to enhance possible benefits and advantages.

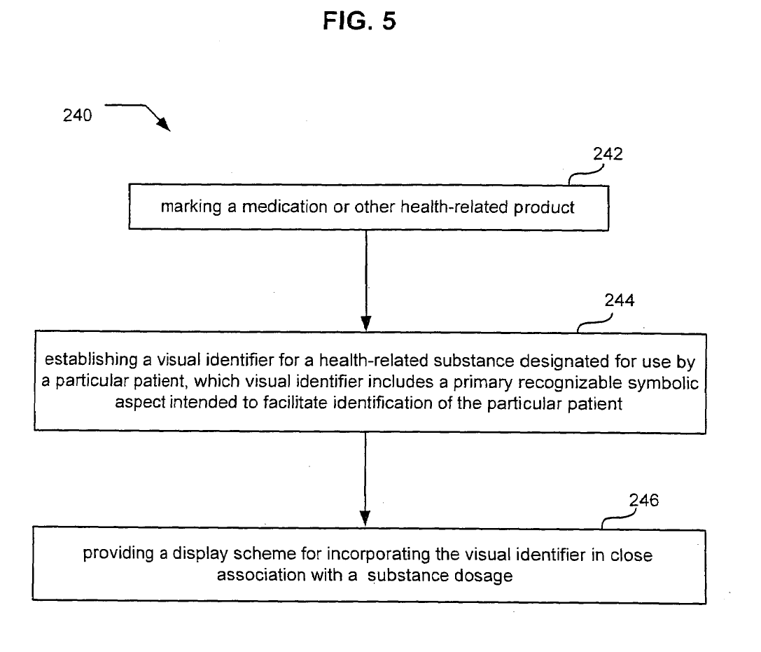

Referring to the exemplary embodiment 240 shown in the high level flow chart of FIG. 5, a process may include marking a medication or other health-related product (block 242), establishing a visual identifier for a health-related substance designated for use by a particular patient, which visual identifier includes a primary recognizable symbolic aspect intended to facilitate identification of the particular patient (block 244), and providing a display scheme for incorporating the visual identifier in close association with a substance dosage (block 246).

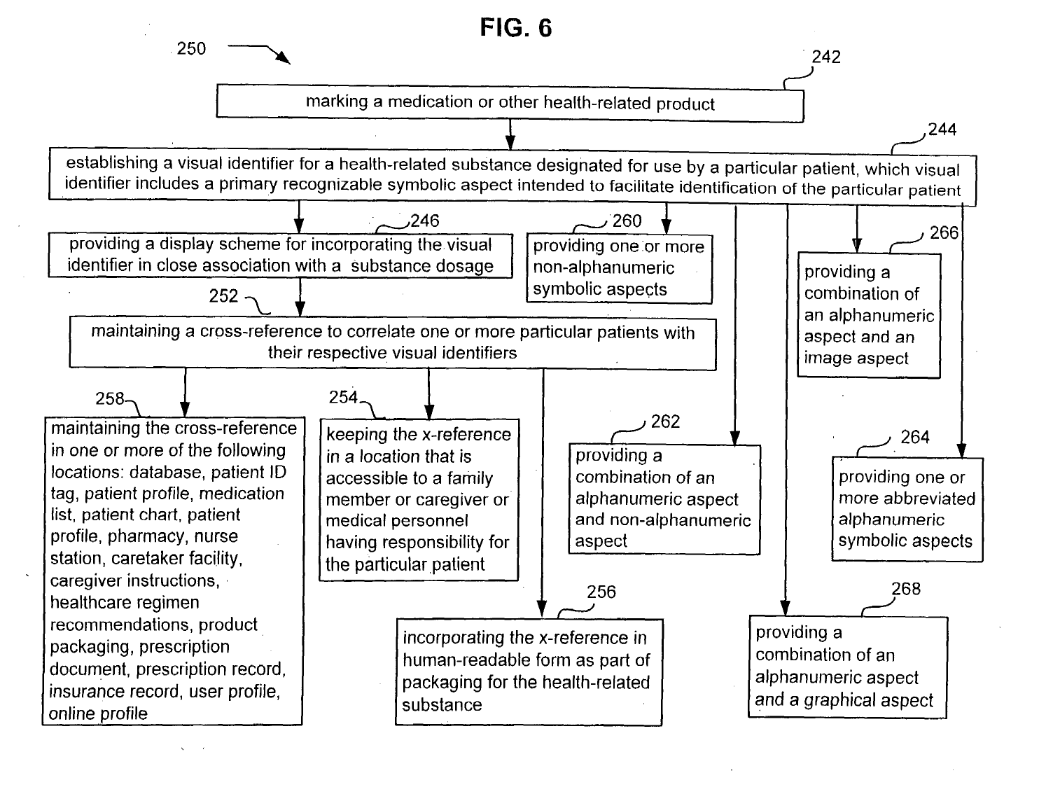

FIG. 6 illustrates additional possible exemplary process features 250 that may include previously described components 242, 244, 246 in combination with maintaining a cross-reference to correlate one or more particular patients with their respective visual identifiers (block 252). Additional possible aspects may include maintaining the cross-reference in one or more of the following locations: database, patient ID tag, patient profile, medication list, patient chart, patient profile, pharmacy, nurse station, caretaker facility, caregiver instructions, healthcare regimen recommendations, product packaging, prescription document, prescription record, insurance record, user profile, and online profile (block 258).

Additional possible aspects may include keeping the cross-reference in a location that is accessible to a family member or caregiver or medical personnel having responsibility for the particular patient (block 254), and incorporating the cross-reference in human-readable form as part of packaging for the health-related substance (block 256).

Other exemplary features shown in the detailed flowcharts of FIG. 6 include providing one or more non-alphanumeric symbolic aspects (block 260), providing a combination of an alphanumeric aspect and non-alphanumeric aspect (block 262), and providing one or more abbreviated alphanumeric symbolic aspects (block 264). Additional possible features may include providing a combination of an alphanumeric aspect and a graphical aspect (block 268), and providing a combination of an alphanumeric aspect and an image aspect (block 266).

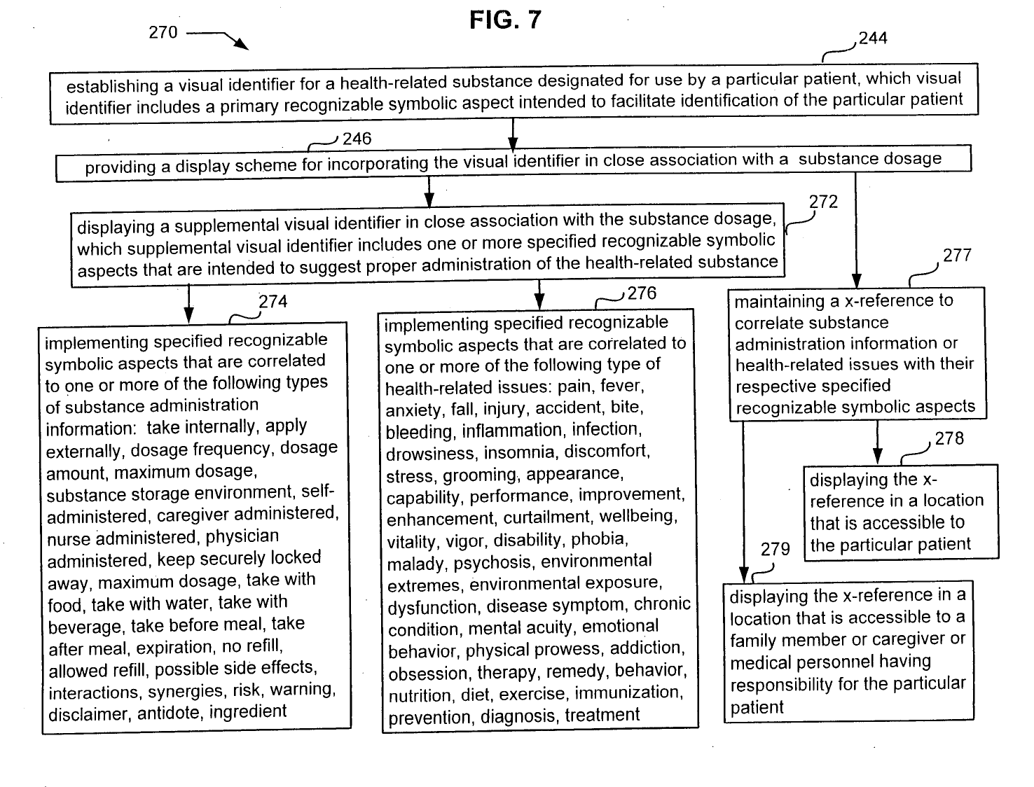

The more detailed flowchart of FIG. 7 discloses additional exemplary embodiment features 270 that include previously described process components 244, 246 along with displaying a supplemental visual identifier in close association with the substance dosage, which supplemental visual identifier includes one or more specified recognizable symbolic aspects that are intended to suggest proper administration of the health-related substance (block 272).

Additional possible implementation features may include implementing specified recognizable symbolic aspects that are correlated to one or more of the following types of substance administration information: take internally, apply externally, dosage frequency, dosage amount, maximum dosage, substance storage environment, self-administered, caregiver administered, nurse administered, physician administered, keep securely locked away, maximum dosage, take with food, take with water, take with beverage, take before meal, take after meal, expiration, no refill, allowed refill, possible side effects, interactions, synergies, risk, warning, disclaimer, antidote, and ingredient (block 274).

Another possible process component shown in FIG. 7 includes implementing specified recognizable symbolic aspects that are correlated to one or more of the following type of health-related issues: pain, fever, anxiety, fall, injury, accident, bite, bleeding, inflammation, infection, drowsiness, insomnia, discomfort, stress, grooming, appearance, capability, performance, improvement, enhancement, curtailment, well being, vitality, vigor, disability, phobia, malady, psychosis, environmental extremes, environmental exposure, dysfunction, disease symptom, chronic condition, mental acuity, emotional behavior, physical prowess, addiction, obsession, therapy, remedy, behavior, nutrition, diet, exercise, immunization, prevention, diagnosis, and treatment (block 276).

Further aspects may include maintaining a cross-reference to correlate substance administration information or health-related issues with their respective specified recognizable symbolic aspects (block 277), displaying the cross-reference in a location that is accessible to the particular patient (block 278), and displaying the cross-reference in a location that is accessible to a family member or caregiver or medical personnel having responsibility for the particular patient (block 279).

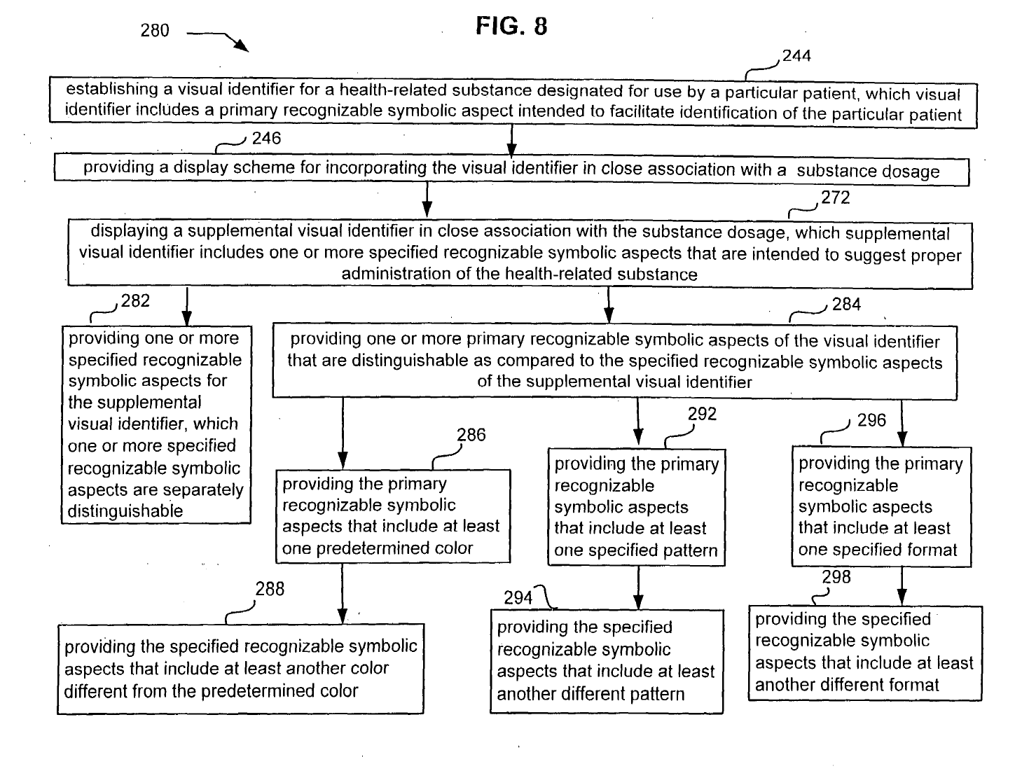

Referring to exemplary embodiment features 280 illustrated in FIG. 8, process components may include previously described features 244, 246, 272 along with providing one or more specified recognizable symbolic aspects for the supplemental visual identifier, which one or more specified recognizable symbolic aspects are separately distinguishable (block 282). Other possible features may include providing one or more primary recognizable symbolic aspects of the visual identifier that are distinguishable as compared to the specified recognizable symbolic aspects of the supplemental visual identifier (block 284).

Other exemplary aspects may include providing the primary recognizable symbolic aspects that include at least one predetermined color (block 286), and providing the specified recognizable symbolic aspects that include at least another color different from the predetermined color (block 288). Additional possible aspects may include providing the primary recognizable symbolic aspects that include at least one specified pattern (block 292), and providing the specified recognizable symbolic aspects that include at least another different pattern (block 294).

FIG. 8 also illustrates additional possible process features including providing the primary recognizable symbolic aspects that include at least one specified format (block 296), and providing the specified recognizable symbolic aspects that include at least another different format (block 298).

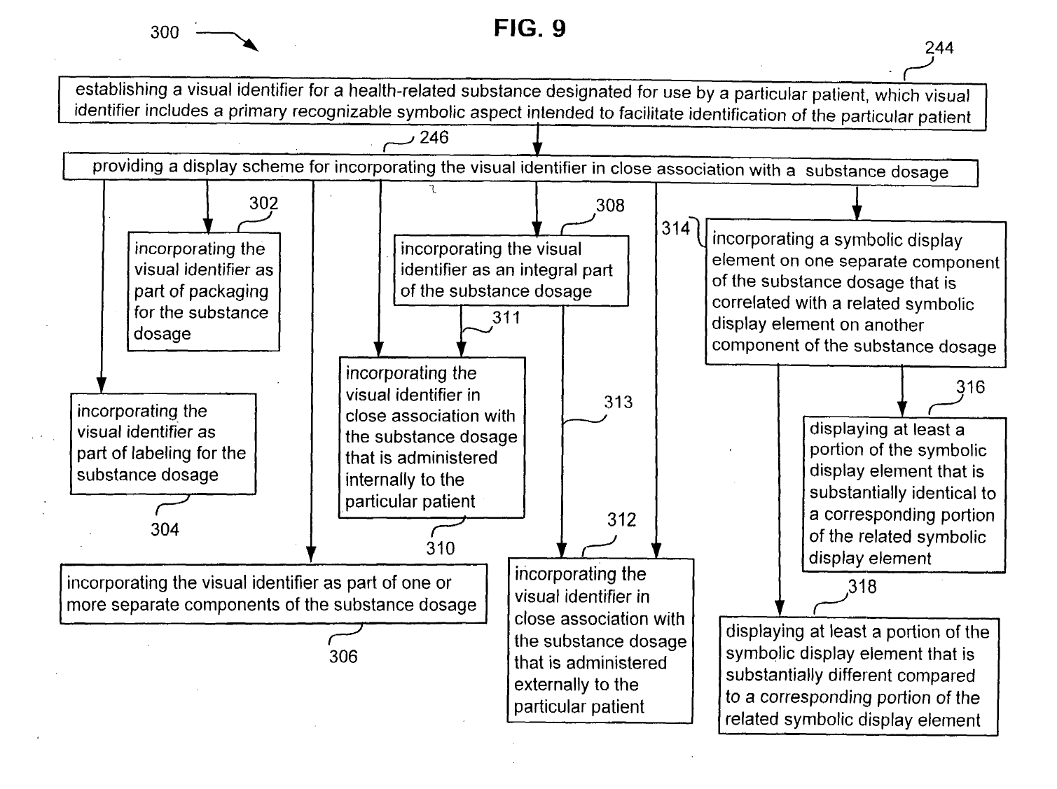

FIG. 9 illustrates additional exemplary embodiments 300 that may include previously described features 244, 246 in combination with other aspects relating to display scheme possibilities for the visual identifier. For example, some possible aspects may include incorporating the visual identifier as part of packaging for the substance dosage (block 302), incorporating the visual identifier as part of labeling for the substance dosage (block 304), and incorporating the visual identifier as an integral part of the substance dosage (block 308).

Additional possible implementation features may include incorporating the visual identifier as an integral part of the substance dosage that is administered internally to the particular patient (block 310) as well as administered externally to the particular patient (block 312). It will be understood that a substance dosage that is administered internally could incorporate the visual identifier as an integral part of the substance dosage (see arrow 311). It will be further understood that a substance dosage that is administered externally could incorporate the visual identifier as an integral part of the substance dosage (see arrow 313) Further exemplary aspects may include incorporating the visual identifier as part of one or more separate components of the substance dosage (block 306). Other possible aspects may include incorporating a symbolic display element on one separate component of the substance dosage that is correlated with a related symbolic display element on another component of the substance dosage (block 314), displaying at least a portion of the symbolic display element that is substantially identical to a corresponding portion of the related symbolic display element (block 316), and displaying at least a portion of the symbolic display element that is substantially different compared to a corresponding portion of the related symbolic display element (block 318).

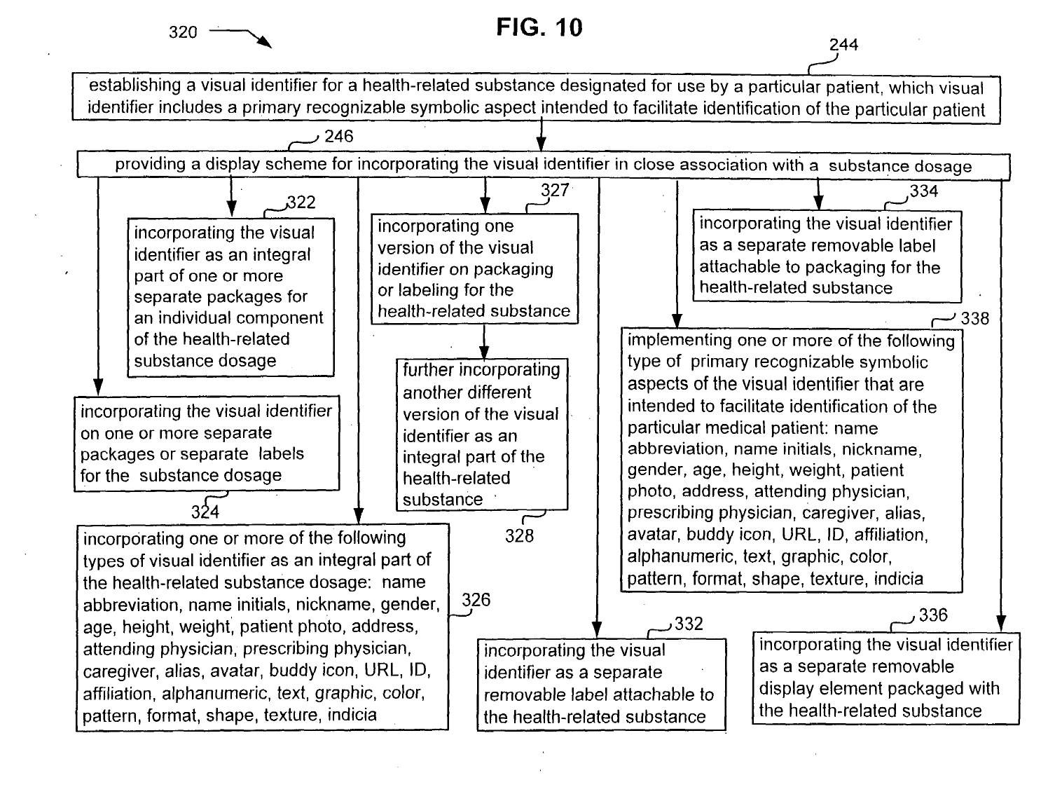

Referring to the detailed flowchart of FIG. 10, various possible embodiment features 320 are illustrated including previously described features 244, 246 in combination with incorporating the visual identifier as an integral part of one or more separate packages for an individual component of the health-related substance dosage (block 322), and incorporating the visual identifier on one or more separate packages or separate labels for the substance dosage (block 324).

Additional exemplary aspects may include incorporating one or more of the following types of visual identifier as an integral part of the health-related substance dosage: name abbreviation, name initials, nickname, gender, age, height, weight, patient photo, address, attending physician, prescribing physician, caregiver, alias, avatar, buddy icon, URL, ID, affiliation, alphanumeric, text, graphic, color, pattern, format, shape, texture, and indicia (block 326).

Other possible process features may include incorporating one version of the visual identifier on packaging or labeling for the health-related substance (block 327), and further incorporating another different version of the visual identifier as an integral part of the health-related substance (block 328). Additional possible aspects may include incorporating the visual identifier as a separate removable label attachable to the health-related substance (block 332) and as a separate removable label attachable to packaging for the health-related substance (block 334). Another related aspect may include incorporating the visual identifier as a separate removable display element packaged with the health-related substance (block 336).

FIG. 10 also illustrates possible exemplary features that may include implementing one or more of the following type of primary recognizable symbolic aspects of the visual identifier that are intended to facilitate identification of the particular medical patient: name abbreviation, name initials, nickname, gender, age, height, weight, patient photo, address, attending physician, prescribing physician, caregiver, alias, avatar, buddy icon, URL, ID, affiliation, alphanumeric, text, graphic, color, pattern, format, shape, texture, and indicia (block 383).

It is to be understood that various aspects of the methods and processes disclosed in FIG. 5-10 can be incorporated in one or more different types of computer program products with a carrier medium having-program instructions encoded thereon. Some exemplary computer program products may be implemented in storage carrier media having program instructions encoded thereon. In some instances exemplary computer program products may be implemented in communication signal carrier media having program instructions encoded thereon.

The exemplary system, apparatus, and computer program product embodiments disclosed herein including FIGS. 1-4 along with other components, devices, know-how, skill and techniques that are known in the art have the capability of implementing and practicing the methods and processes shown in FIGS. 5-10. However it is to be further understood by those skilled in the art that other systems, apparatus and technology may be used to implement and practice such methods and processes. Those skilled in the art will also recognize that the various aspects of the embodiments for methods, processes, products, and systems as described herein can be implemented individually and/or collectively by a wide range of hardware, software, firmware, or any combination thereof.

Exemplary embodiments have been disclosed herein that provide a customized technique for marking medication and other health-related products with a visual identifier that includes a recognizable symbolic aspect to facilitate proper administration of a substance dosage to designated patent. Display implementations of the visual identifier may be incorporated in various product packaging components. A possible supplemental visual identifier may be incorporated in the product packaging components to suggest recommended usage aspects of the substance dosage.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost versus efficiency tradeoffs. Those having skill in the art will appreciate that there are various vehicles by which processes and/or systems and/or other technologies described herein can be effected (e.g., hardware, software, and/or firmware), and that the preferred vehicle may vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle may be deployed and the specific concerns (e.g., speed, flexibility, or predictability) of the implementer, any of which may vary. Those skilled in the art will recognize that optical aspects of implementations will require optically-oriented hardware, software, and or firmware.

The foregoing detailed description has set forth various embodiments of the devices and/or processes via the use of block diagrams, flow diagrams, operation diagrams, flowcharts, illustrations, and/or examples. Insofar as such block diagrams, operation diagrams, flowcharts, illustrations, and/or examples contain one or more functions and/or operations, it will be understood by those within the art that each function and/or operation within such block diagrams, operation diagrams, flowcharts, illustrations, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the-term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true-for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g.,“a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable and/or physically interacting components and/or wirelessly interactable and/or wirelessly interacting components.

As a further definition of “open” terms in the present specification and claims, it will be understood that usage of a language construction “A or B” is generally interpreted as a non-exclusive “open term” meaning: A alone, B alone, A and B together.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of marking a product comprising:
establishing a visual identifier that includes a primary recognizable symbolic aspect intended to facilitate identification of a particular patient;
establishing a supplemental visual identifier that includes one or more specified recognizable symbolic aspects intended to suggest proper administration of a medication or other health-related product; and
providing a display scheme for incorporating the visual identifier and the supplemental visual identifier [in close association with a substance dosage] as part of one or more components of the medication or other health-related product designated for use by the particular patient.

2. The method of claim 1 further comprising:
maintaining a cross-reference to correlate one or more particular patients with their respective visual identifiers.

3. The method of claim 2 wherein said maintaining the cross-reference includes:
maintaining the cross-reference in one or more of the following locations: database, patient ID tag, patient profile, medication list, patient chart, patient profile, pharmacy, nurse station, caretaker facility, caregiver instructions, healthcare regimen recommendations, product packaging, prescription document, prescription record, insurance record, user profile, and online profile.

4. The method of claim 2 further comprising:
keeping the cross-reference in a location that is accessible to a family member or caregiver or medical personnel having responsibility for the particular patient.

5. The method of claim 2 further comprising:
incorporating the cross-reference in human-readable form as part of the one or more components of the medication or other health-related product.

6. The method of claim 1 wherein said establishing the visual identifier includes:
providing one or more non-alphanumeric symbolic aspects.

7. The method of claim 1 wherein said establishing the visual identifier includes:
providing one or more abbreviated alphanumeric symbolic aspects

8. The method of claim 1 wherein said establishing the visual identifier includes:
providing a combination of an alphanumeric aspect and a graphical aspect.

9. The method of claim 1 wherein said establishing the visual identifier includes:
providing a combination of an alphanumeric aspect and an image aspect.

10. The method of claim 1 wherein said establishing the visual identifier includes:
providing a combination of an alphanumeric aspect and non-alphanumeric aspect.

11. (canceled)

12. The method of claim 1 wherein said establishing the supplemental visual identifier includes:
implementing specified recognizable symbolic aspects that are correlated to one or more of the following types of product administration information: take internally, apply externally, dosage frequency, dosage amount, maximum dosage, substance storage environment, self-administered, caregiver administered, nurse administered, physician administered, keep securely locked away, maximum dosage, take with food, take with water, take with beverage, take before meal, take after meal, expiration, no refill, allowed refill, possible side effects, interactions, synergies, risk, warning, disclaimer, antidote, and ingredient.

13. The method of claim 1 wherein said establishing the supplemental visual identifier includes:
implementing specified recognizable symbolic aspects that are correlated to one or more of the following type of health-related issues: pain, fever, anxiety, fall, injury, accident, bite, bleeding, inflammation, infection, drowsiness, insomnia, discomfort, stress, grooming, appearance, capability, performance, improvement, enhancement, curtailment, well being, vitality, vigor, disability, phobia, malady, psychosis, environmental extremes, environmental exposure, dysfunction, disease symptom, chronic condition, mental acuity, emotional behavior, physical prowess, addiction, obsession, therapy, remedy, behavior, nutrition, diet, exercise, immunization, prevention, diagnosis, and treatment.

14. The method of claim 1:
maintaining cross-reference information to correlate product administration information or health-related issues with their respective specified recognizable symbolic aspects.

15. The method of claim 14 further comprising:
displaying the cross-reference information in a location that is accessible to the particular patient.

16. The method of claim 14 further comprising:
displaying the cross-reference information in a location that is accessible to a family member or caregiver or medical personnel having responsibility for the particular patient.

17. The method of claim 1:
providing one or more specified recognizable symbolic aspects for the supplemental visual identifier, which one or more specified recognizable symbolic aspects include one or more of the following type of distinguishable features: alphanumeric, non-alphanumeric, alphanumeric abbreviation, graphical image, icon, indicia, pattern shape, format, and design.

18. The method of claim 1:
providing one or more primary recognizable symbolic aspects of the visual identifier that are distinguishable as compared to the specified recognizable symbolic aspects of the supplemental visual identifier.

19. The method of claim 18 wherein said providing the one or more primary recognizable symbolic aspects that are distinguishable includes:
providing the primary recognizable symbolic aspects that include at least one type of predetermined color or pattern or format; and
providing the specified recognizable symbolic aspects that include at least another different type of color or pattern or format.

20. (canceled)

21. (canceled)

22. The method of claim 1 wherein said providing the display scheme includes:
incorporating the visual identifier as part of packaging or labeling for a substance dosage component of the product.

23. (canceled)

24. The method of claim 1 wherein said providing the display scheme includes:
incorporating the visual identifier as an integral part of a substance dosage component of the product.

25. The method of claim 24 wherein said incorporating the visual identifier includes:
incorporating the visual identifier as an integral part of the substance dosage component that is administered internally to the particular patient.

26. The method of claim 24 wherein said incorporating the visual identifier includes:
incorporating the visual identifier as an integral part of the substance dosage component that is administered externally to the particular patient.

27. (canceled)

28. The method of claim 1 wherein said providing the display scheme includes:
incorporating a symbolic display element of the visual identifier on one separate product component which symbolic display element is correlated to be substantially identical or similar or substantially different as compared to a corresponding portion of a related symbolic display element of the visual identifier on another product component.

29. (canceled)

30. (canceled)

31. The method of claim 1 wherein said providing the display scheme includes:
incorporating the visual identifier as an integral part of one or more separate packages or labels for an individual component of the medication or other health-related product.

32. (canceled)

33. The method of claim 1 wherein said providing the display scheme includes:
incorporating one or more of the following types of visual identifier as part of the medication or other health-related product: name abbreviation, name initials, nickname, gender, age, height, weight, patient photo, address, attending physician, prescribing physician, caregiver, alias, avatar, buddy icon, URL, ID, affiliation, alphanumeric, text, image, graphic, color, pattern, format, shape, texture, and indicia.

34. The method of claim 1 further comprising:
incorporating one version of the visual identifier on packaging or labeling for the medication or other health-related product; and
further incorporating another different version of the visual identifier as an integral part of a substance dosage component of the medication or other health-related product.

35. The method of claim 1 wherein said providing the display scheme includes:
incorporating the visual identifier as a separate removable label attachable to packaging or to a substance dosage component for the medication or other health-related product.

36. (canceled)

37. The method of claim 1 wherein said providing the display scheme includes:
incorporating the visual identifier as a separate removable display element packaged with the medication or other health-related product.

38. The method of claim 1 further comprising:
implementing one or more of the following type of primary recognizable symbolic aspects of the visual identifier that are intended to facilitate identification of the particular [medical] patient: name abbreviation, name initials, nickname, gender, age, height, weight, patient photo, address, attending physician, prescribing physician, caregiver, alias, avatar, buddy icon, URL, ID, affiliation, alphanumeric, text, image graphic, color, pattern, format, shape, texture, and indicia.

39. The method of claim 1 wherein said method is incorporated in one or more computer program products comprising a storage carrier medium or a communication carrier medium having program instructions encoded thereon for executing the method.

40. (canceled)

41. (canceled)

42. A product designated for use by a particular patient, comprising:
a visual identifier that includes one or more recognizable primary symbolic aspects intended to facilitate identification of the particular patient;
a supplemental visual identifier that includes one or more specified symbolic aspects intended to suggest proper administration of a medication or other health-related product: and
a substance dosage component to be administered internally or externally to the particular patient, wherein the visual identifier and the supplemental visual identifier are each incorporated as an integral display characteristic of the substance dosage component and/or as a display element of a package or label in close association with the substance dosage component.

43. The product of claim 42 wherein said visual identifier further includes:
a recognizable primary symbolic aspect intended to facilitate identification of one or more particular patients with a given symptom or deficiency.

44. The product of claim 42 wherein said visual identifier further includes:
one or more recognizable primary symbolic aspects intended to facilitate identification of one or more particular patients having a shared affiliation or grouping.

45. The product of claim 42 wherein said visual identifier further includes:
a recognizable primary symbolic aspect that is capable of facilitating identification of one or more particular patients who are intended recipients of a substance dosage component, wherein such identification can occur without need of any scanner-like device.

46. The product of claim 42 further comprising:
cross-reference data information for correlating one or more particular patients with their respective visual identifiers.

47. The product of claim 46 wherein said cross-reference information includes:
cross-reference information accessible at one or more of the following locations: database, patient ID tag, patient profile, medication list, patient chart, patient profile, pharmacy, nurse station, caretaker facility, caregiver instructions, healthcare regimen recommendations, product packaging, prescription document, prescription record, insurance record, user profile, and online profile.

48. The product of claim 41 wherein said substance dosage further includes:
a substance dosage that incorporates the visual identifier having a distinguishable shape or color or pattern or texture as an integral display characteristic of the substance dosage component.

49. The product of claim 41 further comprising:
packaging or labeling for the substance dosage component, wherein one or more of the following types of visual identifier are incorporated as a display element on the packaging or labeling: name abbreviation, name initials, nickname, gender, age, height, weight, patient photo, address, attending physician, prescribing physician, caregiver, alias, avatar, buddy icon, URL, ID, affiliation, alphanumeric, text, image, graphic, color, pattern, format, shape, texture, and indicia.

50. (canceled)

51. The product of claim 42 further comprising:
separate dosage components of different medicines or health-related products that each display one or more symbolic aspects of the visual identifier.

52. The product of claim 42 wherein said health-related substance includes:
separate dosage components of pharmaceutical and/or non-pharmaceutical products that each display one or more symbolic aspects of the visual identifier.

53. (canceled)

54. (canceled)

55. The product of claim 42 wherein the supplemental visual identifier includes one or more of the following type of distinguishable characteristics: abbreviation color, shape, pattern, texture, format, graphic, image, text, alphanumeric, and indicia.

56. (canceled)

57. (canceled)

58. (canceled)

59. (canceled)

60. The product of claim 42 further comprising:
a data record that provides a cross-reference between the supplemental visual identifier and its correlated product administration information, which data record is accessible at one or more of the following locations: database, patient ID tag, patient profile, medication list, patient chart, patient profile, pharmacy, nurse station, caretaker facility, caregiver instructions, healthcare regimen recommendations, product packaging, prescription document, prescription record, insurance record, user profile, and online profile.

61. (canceled)

62. (canceled)

63. (canceled)

64. (canceled)

65. (canceled)

66. The product of claim 42 wherein said visual identifier includes one or more primary recognizable symbolic aspects that are distinguishable as compared to the specified recognizable symbolic aspects of the supplemental visual identifier.

67. (canceled)

68. The product of claim 42 wherein said visual identifier and said supplemental visual identifier include display elements that are capable of visual recognition without need of a scanner-like device.

69. A marking system for a health-related product, that is designated for a particular patient comprising:
a visual identifier that includes a primary recognizable symbolic aspect intended to facilitate identification of the particular patient;
a supplemental visual identifier that includes one or more human-readable specified symbolic aspects applicable to diagnostic or measurement or treatment or therapeutic administration features of the health-related product;
one or more additional components for use in connection with such administration of the health-related product, wherein each such additional component displays one or more human-readable elements of the visual identifier; and
a display implementation that incorporates the supplemental visual identifier to be in close association with such one or more additional components of the health-related product.

70. The system of claim 69 further comprising:
cross-reference data information for correlating the particular patient with one or more of the visual identifiers.

71. The system of claim 69 further comprising:
a record that provides a cross-reference correlation between the supplemental visual identifier and the applicable administration features of the health-related product.

72. The system of claim 69 wherein said visual identifier includes:
a symbolic display element on one separate component of the packaging system that is correlated with a related symbolic display element on another component of the marking system.

73. The system of claim 72 wherein the symbolic display element is incorporated as part of a substance dosage component, and the related symbolic display element is incorporated as part of a container component or a labeling component.

74. The packaging system of claim 72 wherein a symbolic display element serves a dual function to facilitate identification of a particular patient as well as to suggest the applicable administration features of the health-related product.

75. A computer program product having one or more programs operable to perform a process, wherein said process comprises:
establishing a visual identifier for a health-related product designated for use by a particular patient, which visual identifier includes a primary recognizable aspect intended to facilitate identification of the particular patient;
establishing a supplemental visual identifier that includes one or more specified symbolic aspects applicable to diagnostic or measurement or treatment or therapeutic administration features of the health-related product;
implementing a display scheme for incorporating a human-readable form of the visual identifier and the supplemental visual identifier in close association with the health-related product; and
maintaining a cross-reference to correlate the particular patient with the visual identifier.

76. The computer program product of claim 75 wherein said process further includes:
maintaining a record that provides a cross-reference correlation between the supplemental visual identifier and the applicable administration features of the health-related product.

77. The computer program product of claim 75 further comprising:
carrier media incorporating program instructions for executing said process, wherein said carrier media includes storage medium and/or communication medium.
